(19) United States
(12) Patent Application Publication
(10) Pub. No.: US 2026/0003328 A1
(43) Pub. Date: Jan. 1, 2026

(54) MEMORY-BASED LEARNING (MBL) CONTROLLERS

(71) Applicant: Mitsubishi Electric Research Laboratories, Inc., Cambridge, MA (US)

(72) Inventors: Daniel Nikovski, Brookline, MA (US); Junmin Zhong, Tempe, AZ (US); William Yerazunis, Acton, MA (US)

(73) Assignee: Mitsubishi Electric Research Laboratories, Inc., Cambridge, MA (US)

(21) Appl. No.: 18/757,207

(22) Filed: Jun. 27, 2024

(51) Int. Cl. G05B 13/04; G05B 13/02

(52) U.S. Cl. CPC G05B 13/04; G05B 13/0265

(57) ABSTRACT

Systems, methods, software, and devices are disclosed herein related to trajectory computation by way of a memory-based learning (MBL) controller. An MBL controller in various embodiments stores a set of trajectories in memory. The trajectories connect various initial states of a dynamical system with a target state. In addition to the memory, the controller further includes a processor that collects a current state of the dynamical system and determines, using memory-based learning (MBL) on training instances derived from the set of trajectories, a control policy that defines a trajectory connecting the current state of the dynamical system with the target state. The processor controls the dynamical system according to the control policy.

### TECHNICAL FIELD

Aspects of the disclosure are related to the field of control systems and, in particular, to controllers and trajectory optimization solutions.

### BACKGROUND

In the field of control theory, control systems are designed to manipulate the behavior of a system (such as a mechanical system, electrical circuit, or chemical process) to achieve a desired performance. A control system includes: a plant (or system) that represents the physical system to be controlled (e.g., a robot arm, an aircraft, or a temperature-controlled oven); a controller, which is the element responsible for generating control signals to influence the plant's behavior; and in some cases a feedback loop that provides feedback to the controller.

Trajectory optimization is a sub-domain of control theory related to the computation of a trajectory that optimizes some measure of performance while satisfying a set of constraints. For example, in manufacturing, a controller may employ an algorithm to compute the optimal trajectory of a robotic arm to move an object from one place to another while avoiding obstacles. In an aerospace example, a controller may be tasked with navigating a vehicle from an origin to a destination while optimizing for fuel consumption. Such algorithms tend to be computationally expensive, and improvements are constantly sought with respect to their efficiency and applicability in real-world settings. For instance, for a control algorithm to be practical, it must be both accurate and be fast enough for real-time control.

Recent advances have led to the application of artificial intelligence and machine learning to trajectory optimization to provide both fast and accurate algorithms. One technique involves training deep neural networks to reproduce (emulate) pre-computed control policies. The control policies may be computed offline using a suitable trajectory optimization algorithm such as the Iterative Linear Quadradic Regulator (iLQR), starting from different initial states. The collection of computed trajectories from the different initial states implicitly defines a global control policy. Each trajectory includes a set of points that each represent—at a minimum—a current state and a nominal control action to take to progress to a next state. At a simplistic level, a neural network may thus be trained to output a nominal control action based on the current state of a system under control. The generalization properties of neural networks can be leveraged to compute suitable control actions for states that were not part of the trajectories used for training, but lying in-between them. However, using neural networks has the associated problems of long training times, lack of guarantees about convergence, and inconsistency between examples.

### SUMMARY

Systems, methods, and software are disclosed herein that improve trajectory computation by way of a memory-based learning (MBL) controller. Various technical effects and other advantages may be appreciated from the MBL controller technology disclosed herein, including the improved speed and accuracy of said controllers.

An MBL controller in various embodiments stores a set of trajectories in memory. The trajectories connect various initial states of a dynamical system with a target state. In addition to the memory, the controller further includes a processor that collects a current state of the dynamical system and determines, using memory-based learning (MBL) on training instances derived from the set of trajectories, a control policy that defines a trajectory connecting the current state of the dynamical system with the target state. The processor controls the dynamical system according to the control policy. This control policy is valid not only for the states that belong to one of the trajectories stored in memory, but also for other all other states in the state space of the system.

Additionally, or alternatively, each of the trajectories includes a sequence of points connecting an initial state with the target state. Each point is associated with an intermediate state of the mechanical system, gains of a feedback controller for controlling the mechanical system in the intermediate state, and a cost-to-go from the intermediate state to the target state along a corresponding trajectory including the point. The cost-to-go is defined as the cumulative performance criterion of the control problem aggregated over all states of the trajectory from the current state to the target state, if the feedback controller stored with the trajectory is employed. At least some points of the corresponding trajectory may be associated with different gains of the feedback controller, and the trajectories may have been determined for an infinite time horizon resulting in time agnostic gains of the feedback control and the cost-to-go.

Additionally, or alternatively, a modified iLQR algorithm may be employed to pre-compute the trajectories that are stored in the controller's memory, resulting in time-invariant trajectories. The time-invariant trajectories may be achieved by initializing the backward iteration of iLQR with the cost-to-go of an LQR controller at the goal state. The processor may then compare directly the costs-to-go of the closest states belonging to one of the precomputed solutions, and choose the control action associated with the state with the best cost-to-go.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in an embodiment that includes an MBL controller.

FIG. 2 illustrates a method of operating an MBL controller in an embodiment.

FIG. 3 illustrates an operational sequence in an embodiment.

FIGS. 4A-4B illustrate an operational scenario in an embodiment.

FIGS. 5A-5B illustrate another operational scenario in an embodiment.

FIG. 6 illustrates a method for pre-computing training data in an embodiment.

FIG. 7 illustrates another operational environment in an embodiment.

FIG. 8 illustrates a graph that depicts actual computed trajectories mapped against a set of training solutions in an embodiment.

FIG. 9 illustrates a graph that depicts a success rate of different MBL techniques in various embodiments.

FIG. 10 illustrates a computing system suitable for implementing the various controllers, architectures, processes, scenarios, and sequences discussed below with respect to the other Figures.

### DETAILED DESCRIPTION

Computing an optimal feedback controller for an arbitrary nonlinear system is very difficult in the general case, and usually, various custom solutions are employed for specific classes of nonlinear systems. In some cases, an optimal trajectory can be computed for a given initial and goal state and executed in an open loop. This would not work well when disturbances are present, but if the optimal trajectory is re-computed quickly, and only the first control from it is applied at each control step, a form of closed-loop control can be achieved (commonly called model-predictive control, MPC). However, the success of such MPC schemes often depends on the length of the predictive horizon over which trajectories are computed. For some systems, relatively short horizons are sufficient, but for others, such as non-minimum phase systems where the controller needs to move away from the goal state initially and approach it only later, the re-computation of the entire trajectory to the goal at each control step might be necessary, placing big demands on computing power and effectively reducing the achievable control rate. This limits the applicability of such entirely online methods (also called implicit MPC schemes).

Explicit Model Predictive Control is a variant of Model Predictive Control that computes the control actions offline for all possible states and inputs. This means that instead of solving an optimization problem online at each time step, the control law is precomputed and stored in a lookup table or a parametric form. This approach has the advantage of reduced online computation time, making it suitable for real-time applications where quick decisions are necessary. However, the explicit MPC can be computationally expensive for systems with large state and input spaces. Indeed, the memory segmentation for storing the mapping between states and control actions can increase exponentially making the explicit MPC method impractical.

Recently, the same principles underlying explicit MPC but combined with the generalization abilities of machine learning methods have been used by deep reinforcement learning (DRL) algorithms that use deep neural nets to store the control policy (and possibly, the value function) in a deep neural net, significantly increasing the dimensionality and complexity of problems that can be solved this way. The computed policies that are stored in deep neural nets can typically be executed very quickly, allowing for very high control rates. However, this approach has many shortcomings, such as dependency on training data and the need to retrain the policy with each change of the dynamics and/or control objectives.

A middle ground between implicit MPC, on one hand, and explicit MPC and DRL, on the other, is to compute local trajectories connecting some specific states of the mechanical system with the target state and train a neural network using these trajectories to provide a global control policy for controlling the system from any state to the target state. This approach jointly uses model-based and model-free computations and can be efficient for some applications. However, using neural nets has the associated problems of long training times and lack of guarantees about convergence. Furthermore, neural nets do not enforce consistency between examples.

Accordingly, there is still a need to extend control based on locally generated trajectories with the principle of machine learning and/or artificial intelligence to produce a global control policy suitable for controlling a mechanical system having nonlinear dynamics from any desired initial state in its state space.

To that end, controllers are disclosed herein that are both fast enough and accurate enough for real-world applications such as robotic arm control, vehicle control, and the like, by using a class of MBL algorithms to produce optimal control policies. The MBL algorithms—which are also often referred to as non-parametric methods-include the k-nearest neighbor (K-NN), locally weight learning (LWL), and locally weighted regression (LWR) algorithms. Such algorithms provide an advantage relative to deep neural networks in that no computational effort need be spent on training-rather, all the training data is stored in the controller's memory and a local predictive model may be quickly constructed for a specific query point at runtime.

Additionally, or alternatively, various algorithms may be employed to generate the trajectories that are stored in memory, from which the MBL training data is derived, examples of which include Differential Dynamic Programming (DDP), iLQR, and the like.

In at least one embodiment, the stored trajectories include only the nominal controls from the iLQR solutions. In another embodiment, both the nominal controls and the gains from the iLQR solutions are stored in memory and utilized by the controller at runtime. In yet another embodiment, the nominal controls, gains, and costs-go-go are stored in memory and utilized by the controller at runtime.

At least one embodiment employs a modified, time-independent version of iLQR to produce the stored trajectories. The modified iLQR algorithm pre-computes time-invariant trajectories by initializing the backward iteration of iLQR with the cost-to-go of an LQR controller at the goal state. At runtime, the controller compares directly the costs-to-go of the closest states belonging to one of the precomputed solutions and chooses the control action associated with the state with the best cost-to-go.

More generally, it is an object of some embodiments to provide a system and a method for controlling a mechanical system having nonlinear dynamics. Additionally or alternatively, it is an object of some embodiments to provide a controller suitable to control the mechanical system from various different initial states to a target state and maintain the system at that target state. Additionally or alternatively, it is an object of some embodiments to provide a controller suitable to control the mechanical system subject to unknown disturbance and/or over a long distance toward the target state allowing temporary cost increases during the control. Additionally or alternatively, it is an object of some embodiments to provide a controller suitable to be implemented on an embedded system with limited computational power.

Some embodiments are based on realizing that machine learning of a global control policy from local trajectories can be realized by means of memory-based learning (MBL) to address some shortcomings of neural networks applied to the control. Memory-based learning is a machine learning approach that uses stored data instances to make predictions or decisions. Instead of explicitly building a model, as with neural networks, memory-based learning algorithms memorize the training dataset and use it during the prediction phase.

The memory-based learning stores the training instances (examples) in memory. This could be the entire dataset or a subset, depending on the algorithm. In some embodiments, the training instances are local trajectories. In theory, when the new trajectory from a specific state needs to be estimated, the MBL can look for similar states in the training data (usually using a similarity measure like Euclidean distance or cosine similarity) and estimate a new instance of trajectory based on the outcomes of the most similar instances in the training data. For example, the MLB can interpolate the control actions using averaging the outcomes k-Nearest Neighbors (k-NN) method.

However, while the MBL methods can address the shortcomings of training a single control policy model, to provide an MBL to control a practical system with complex non-linear dynamics there is a need for an extensive set of local trajectories. Storing such a large training dataset can be memory-intensive and computationally expensive.

Typically, a local trajectory includes a mapping between a sequence of states and a sequence of control actions moving the mechanical system from a state on the trajectory to the target state. However, some embodiments are based on recognizing that a number of local trajectories suitable for synthesizing a global control policy using the MBL method can be reduced if the local trajectory includes not only the states and corresponding control actions, but also one or a combination of the gains of the feedback control and cost-to-go to the target state from the states of the local trajectories. Having this info allows for interpolation of not only control actions for an arbitrary state different from the states of the trajectories but also interpolation of the feedback gains and costs of control from the arbitrary state to the target state. This information combined with the interpolation of the control action provides more accurate results than just the interpolation of the control actions.

However, in contrast with the control actions of different local trajectories, the feedback gains and cost-to-go of different states are dependent on time. This is because the local trajectories are typically determined as a solution to finite-time optimization as time affects the specifics of the control. Indeed, finite-time optimization provides a practical framework for designing control policies that meet specific performance criteria within a finite duration. It allows for the consideration of time-sensitive objectives and constraints, making it a versatile tool in control system design and optimization. However, this time dependency makes the gains and costs interpolation unsuitable for the MBL scheme.

To address this problem, some embodiments determine the local trajectory as a solution of infinitetime-horizon optimization. Infinitetime-horizon optimization refers to the process of optimizing a control policy over an infinite time horizon. This is done in the context of optimal control problems, where the goal is to find a control policy that minimizes a cost function over an infinite time horizon, subject to system dynamics and possibly other constraints. One approach to infinite-time optimization is to use the Linear Quadratic Regulator (LQR) method. In this method, the goal is to find a control policy that minimizes a quadratic cost function over an infinite time horizon. The optimal control policy for this problem is often found by solving the associated algebraic Riccati equation. When the system dynamics are linear and time invariant, the solution of the infinite-horizon LQR problem can be obtained analytically, and is also time invariant, that is, the computed control policy depends only on state, but not on time. In contrast, when the system dynamics are nonlinear, an analytical solution is not known, and solving an infinite-horizon LQR problem numerically is generally not feasible.

However, in certain circumstances, including the problem when the controller needs to bring the system to a target state and maintain it there infinitely, it is possible to formulate the corresponding infinite-time optimization problem by adding a terminal cost to the finite-time optimization problem, and solving it by using an infinite-time regularizer to an Iterative Linear Quadratic Regulator (iLQR) solution. Doing this in such a manner makes the feedback gains and costs-to-go time-invariant, allowing their interpolations during the MBL.

For example, some embodiments disclose nonlinear controllers designed based on the application of memory-based learning schemes to aggregate multiple solutions produced by optimal control algorithms based on, for example, differential dynamic programming (DDP) or iLQR. The embodiments leverage the possibilities of some optimal control algorithms to produce not only nominal state and control trajectories but entire full-state feedback (FSF) controllers, allowing the combined controller to effectively switch between these multiple FSF controllers.

Furthermore, some embodiments leverage the possibilities of some optimal control algorithms to compute not only nominal state and control trajectories but the costs-to-go for all states in the neighborhood of states in the nominal state trajectory. One embodiment computes the expected cost-to-go according to the estimates of the k nearest states, and chooses the controller associated with the trajectory state whose cost-to-go for the current system state is the lowest. This trajectory state does not necessarily have to be the closest state in the system's state space.

In other embodiments, by employing MBL schemes, the costs-to-go of all states in the close neighborhood of the current state can be approximated based on the costs-to-go of the closest states in the stored nominal trajectories. This approximation, along with the linearization of the system dynamics around the current system state, can be used to solve efficiently the Hamilton-Jacobi-Bellman equation of optimal control to compute the optimal control for the current system state.

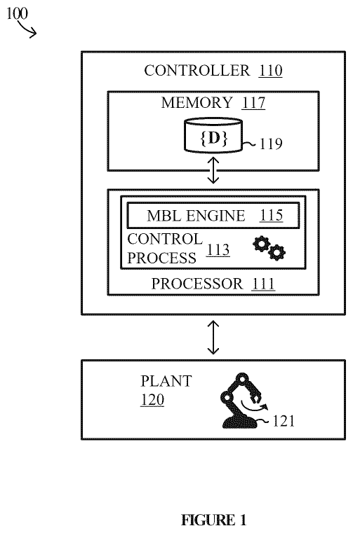

FIG. 1 illustrates an operational environment 100 in an implementation of MBL controllers. Operational environment 100 includes controller 110 and plant 120. Controller 110 includes processor 111 and memory 117. Processor 111 hosts control process 113 that includes a memory-based learning (MBL) engine 115. MBL engine 115 interfaces with data set 119 stored in memory 117. Plant 120 is representative of a mechanical system that is dynamical in that its state changes over time can be mathematically modeled.

Controller 110 is representative of a device configured to execute a control algorithm (e.g. control process 113) to control plant equipment such as robots, robot arms, vehicles, processes, or the like. Controller 110 may be, for example, a micro controller unit (MCU) deployed in the context of a manufacturing environment, a flight control unit deployed in the context of an aerospace environment, or any other type of controller executing in any of a variety of applicable environments.

Processor 111 is representative of one or more hardware devices configured to execute firmware and/or software in furtherance of said control provided by controller 110. Examples of processor 111 include a central processing unit (CPU), a graphical processing unit (GPU), a digital signal processor (DSP), an application specific integrated circuit (ASIC), logic devices, as well as any other type of processing device, combinations, or variations thereof.

Control process 113 is representative of program instructions embodied in firmware and/or software that, when executed by processor 111, enable controller 110 to control one or more aspects of a plant with respect to computed trajectories. Control process 113 includes MBL engine 115, which accesses training data 119 to compute said trajectories.

Training data 119 includes a set of trajectories pre-computed in accordance with a suitable trajectory optimization algorithm. Each trajectory in the set of trajectories includes a set of points connecting an origin state to a goal state. Each point represents a unique state along the trajectory. Training data 119 includes, in addition to each point of each trajectory, an output corresponding to each point. The corresponding outputs include, for example, the nominal controls determined by the trajectory algorithm to transition a system from one state to the next (or from one point along the trajectory to the next). In addition or alternatively, the outputs corresponding to the inputs may also include gain values.

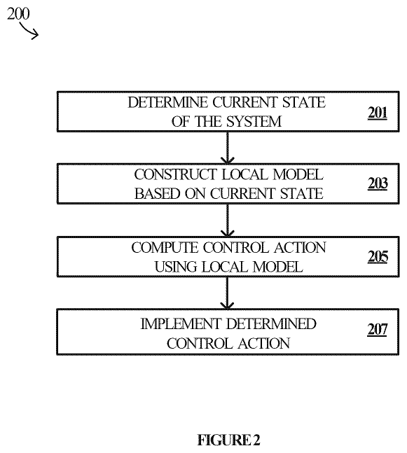

FIG. 2 illustrates an MBL process employed to compute trajectories, referred to herein as process 200. Process 200 may be implemented in program instructions in the context of the software and/or firmware elements of a system controller. The program instructions, when executed by one or more processing devices of a controller, direct the controller to operate as follows, referring parenthetically to the steps in FIG. 2.

In operation, the controller determines the current state of a system under control (step 201). For example, the controller may determine based on sensor input the position of a robotic arm, the position of an unmanned aerial vehicle, the temperature or pressure of an industrial processor, or the like. Such data represents the current state of the plant or system under control. Examples of systems under control include mechanical systems, software systems, or any other types of dynamical systems that may be represented mathematically by a model that describes how the system's state changes over time. Examples of dynamical systems include aerospace environments, robotics applications, vehicle control, and other such mechanical systems. However, examples of dynamical systems also include non-mechanical systems such as models of population dynamics in a city, disease processes, and the like.

Next, the controller constructs a local model using MBL based on the current state of the system (step 203). Constructing the local model includes, for example, querying an in-memory data set based on the current state to obtain, from one or more trajectories in the set, one or more outputs corresponding to the current state. The outputs include nominal control actions and may optionally include the gains associated with each control action and cost-to-go. The controller proceeds to compute a control action based on the local modal constructed from the training data (step 205). A variety of algorithms may be used to compute the control action such as k-NN, LWL, and the like. At a high level, the controller selects one or more points from the in-memory set of trajectories based on their state and optionally based on their cost-to-go.

The controller then implements the determined control action with respect to the plant under control (step 205). Implementing the control action may include generating a reference signal based on the control action (e.g., setpoints for achieving a position, velocity, or orientation) and converting the reference signal to a control command understood by the underlying plant equipment. For instance, the control action may be converted to reference signal such as a joint angle for a robotic arm or a desired speed for a vehicle. The reference signal may then be converted to a control command such as a voltage command for a motor, adjustments to value positions in a hydraulic system, or modulating current to a heater.

The controller communicates the control commands to actuators or other such plant equipment that physically executes the commands. Example equipment includes motors, servos, and solenoids. Sensors such as encoders, accelerometers, and cameras may provide feedback to the controller. The controller receives the sensor data and returns to Step 201, upon which it repeats process 200 until it reaches or sufficiently nears the goal state.

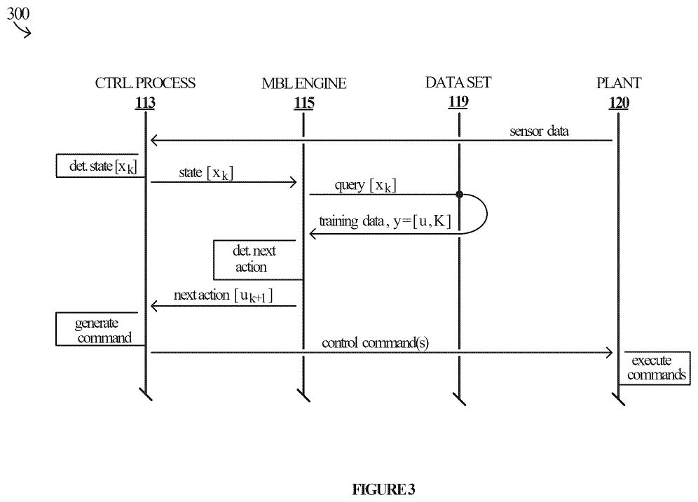

FIG. 3 illustrates operational sequence 300, which is representative of an application of process 300 with respect to the elements of operational environment 100. In operation, control process 113 executing on controller 111 determines the current state of plant 120 based on sensor data or other such input, represented by xₖ. Control process 113 provides the state to MBL engine 115, which uses it as the basis to query data set 119.

MBL engine 115 queries data set 119 for one or more points along one or more of the set of trajectories stored in memory 117 and uses the resulting data to build a local model. The data points are selected based on their corresponding states and their relative distance from the current state, and optionally based on their cost-to-go. The point data obtained from data set 119 includes at least the nominal controls for points corresponding to the current state and may optionally include gain data. The data retrieved from data set 119 is considered training data with which MBL engine 115 computes a next control action, and is represented by y=[u, K], where u represents one or more nominal controls, and K represents one or more gain values.

MBL engine 115 determines a next action uₖ₊₁ based on the training data obtained from data set 119, and provides the next action to control process 113. Control process 113 generates a control command based on the next action and sends the command to plant 120. Plant 120 then executes the command to transition all or a portion of the plant or system to a next desired state.

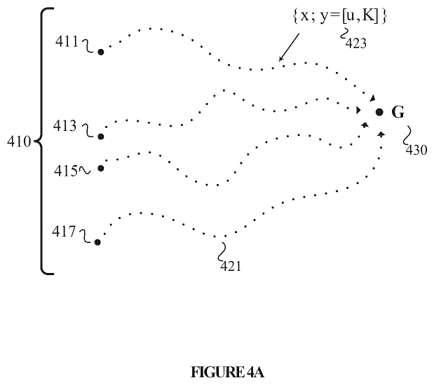

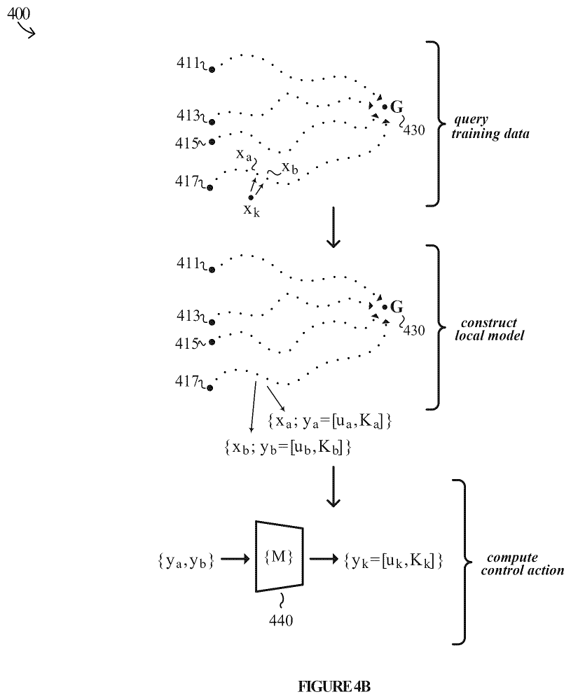

FIG. 4A illustrates a set of trajectories representative of data set 119 stored in memory 117. Trajectories 410 include trajectory 411, trajectory 413, trajectory 415, and trajectory 417. Each one of the trajectories includes a set of points that connect the trajectory from a starting point to a goal state 430. Point 421 along trajectory 417 is representative of a point. Point data 423 represents the data stored in association with each point. Namely, each point is defined by a state (xₙ) and a corresponding control (uₙ). As mentioned, the point data may also include the gain (Kₙ) for the control.

FIG. 4B illustrates operational scenario 400, which is also representative of an application of process 200 but with respect to the set of trajectories 410 in FIG. 4A. In operation, a controller determines the current state of a system under control (xₖ). The state may represent, for example, a single or multi-dimensional state such as temperature, location, or the like. Next, the controller constructs a local model using MBL based on the current state of the system. Here, the controller identifies two points (xₐ and x_{b}) along trajectory 417 that are its nearest neighbors, assuming a nearest neighbors' scheme where k=2, based on a distance in state-space between the current state and the points of the trajectories. While the points in this example are one a single trajectory, the points could be drawn from different trajectories in some implementations. It may also be appreciated that a single nearest neighbor may be found, too.

Cost-to-go may also be used as a factor in the point selection in some implementations. For example, the cost-to-go of each of the k-nearest states may be computed and the state(s) having the lowest costs may be selected. The cost-to-go from each of the k-nearest states may be pre-computed and stored with the trajectory data. Alternatively, the cost-go-go from each of the k-nearest states could be computed at runtime.

A local model is constructed using the output values associated with the two points on trajectory 417. The two points are represented by a first input/output pair (xₐ, yₐ) and a second input/output pair (x_{b}, y_{b}). That is, states xₐ and x_{b} are the two nearest points to xₖ amongst the points of all the trajectories in the set, and their outputs are yₐ and y_{b} respectively. More specifically, their outputs include at least a nominal gain (u) and optionally, gain (K). Thus, yₐ=[uₐ, xₐ, Kₐ], and y_{b}=[u_{b}, u_{b}, K_{b}].

The output values are supplied as input to a local model 440 that, when executed, computes a final output y=[u, x, K], wherein u represents a nominal control action and K represents a gain value for an FSF controller that, when applied to the system, will transition the current state of the system xₖ to a next state xₖ₊₁. The controller generates a control command based on the model's output and sends the command to the subject plant element(s) to be executed.

The applied action uₖ may be computed based on uₐ and Kₐ as well as u_{b} and K_{b}. For instance, the control values for the two points may be averaged together and the gain values for the two points may be averaged together. In some cases, weighting may be applied to the control and gain values of each point based on their proximity to the current state. In still other examples, the points with the lowest cost-to-go may be selected. For instance, uₖ may be computed based on uₐ and Kₐ (and not up and K_{b}.) if xₐ has a lower cost-to-go than x_{b}.

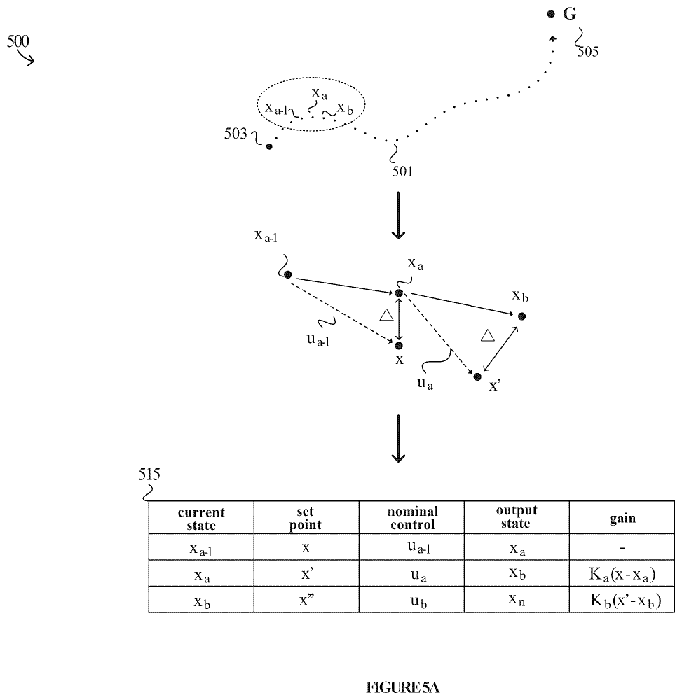

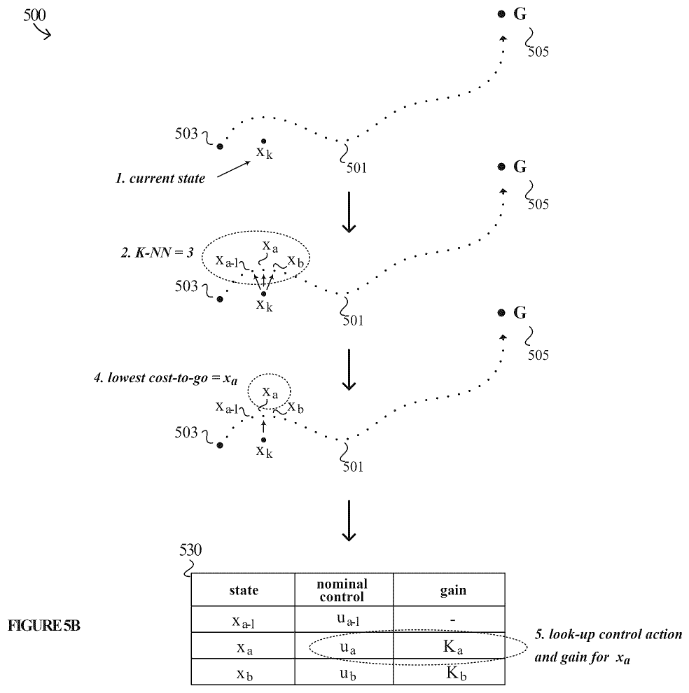

FIGS. 5A-5B illustrate another operational scenario 500 in an embodiment. Operational scenario 500 depicts a highly simplified example that focuses on a single pre-computed trajectory and the subsequent use of points on the trajectory to compute a control action at runtime. In FIG. 5A, operational scenario 500 begins with the computation of trajectory 501. Trajectory 501 is representative of a trajectory that may be pre-computed for purposes of storing in memory with a set of training data (e.g., trajectories 410 in FIG. 4). Trajectory 501 includes a starting point 503, a goal 505, and numerous points in between, each representative of different states along the trajectory. Here, points xₐ₋₁, xₐ, and x_{b} represent three (3) consecutive points or states along trajectory 501.

Each point along trajectory 501 is identified by its state, a set point that was the input to a control loop for that point during the computation of trajectory 501, a nominal control determined and applied at that state to transition the system to a next desired state, a measured output state, and a gain calculated based on a difference between the measured output state and the set point. For example, at state xₐ₋₁, a nominal control action uₐ₋₁ is assumed to have been computed based on a set point x. That is, the input to a control loop was x, meaning that the control loop desired to transition the system from state xₐ₋₁ to x. (Gain at this step is not applicable although it may be involved). The input x resulted in the nominal control uₐ₋₁. The measured output was xₐ, which also represents the next state.

Note that that the measured output (or actual next state) differed from the set point (or desired next state). Such differences may occur due to real-world disturbances such as wind, random errors, or the like, all of which may be simulated by a physics model leveraged to generate trajectory 501. The difference between x and xₐ is factored into the computation of gain K for state xₐ. That is, gain Kₐ for state xₐ is determined based on the difference between state xₐ and the desired state (or set point) x associated with previous state xₐ₋₁.

With respect to state xₐ, a new setpoint x′ is assumed to have been input to the control loop which also considers gain Kₐ. The output of the control loop was nominal control uₐ, which when applied resulted in the transition of the system from xₐ to x_{b}. Note that that the measured output again differed from the set point. The difference between x′ and x_{b} is factored into the computation of gain K for state x_{b}. In other words, gain K_{b} for state x_{b} is determined based on the difference between state x_{b} and the desired state (or set point) x′ associated with previous state xₐ. A similar process may be assumed for x_{b} where a new set point x″ and gain K_{b} are the inputs to the control loop. A nominal control up is output which is assumed to transition the system from state x_{b} to state xₙ. The data produced during the pre-computation of trajectory 501 may then be deployed to a runtime controller as training data leveraged to compute real-time control actions. FIG. 5B, in a continuation of operational scenario 500, illustrates one such application of the training data.

In FIG. 5B, a dynamical system (mechanical or otherwise) under real-time control is at current state xₖ. The controller first identifies points along one or more trajectories that are the k-nearest neighbors to the current state. Here, K=3 and as such, the controller identifies the three (3) nearest neighbors to state X−K amongst the trajectories in the training data which, for exemplary purposes, are the same points xₐ₋₁, xₐ, and x_{b} highlighted in FIG. 5A. (While only trajectory 501 is shown for exemplary purposes, it may be appreciated that multiple other trajectories would be included in the training data).

Next, the controller filters the nearest neighbor list based on a cost-go-to either known or computed for each of the points in the set. While shown here as a discrete step that follows the nearest neighbor search, it may be appreciated that cost-to-go could be a factor in the nearest neighbor search itself. However, for illustrative purposes, it is assumed that the cost-go-to analysis is used to select a final point with which to determine a control action for xₖ.

The cost-to-go step results in the selection of point xₐ along trajectory 501. (While only a single point is used herein for exemplary purposes, it may be appreciated that multiple points could result from the cost-to-go analysis.) Accordingly, the controller accesses training data 530 (stored in its memory) to obtain the nominal control action uₐ associated with state xₐ, as well as the gain Kₐ associated with state xₐ. Per the examples discussed above with respect to FIGS. 4A-4B, the nominal control action uₐ and gain Kₐ are utilized to determine the final control action uₖ at state xₖ. Using the gains in addition to the nominal control actions stored in memory for the pre-computed trajectory training data allows the controller to bring the state of the system closer to a solution faster than otherwise.

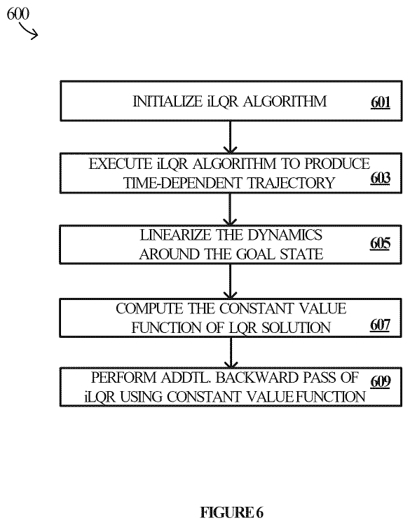

The set of trajectories 410 illustrated in FIGS. 4A and 4B, as well as trajectory 501 in FIGS. 5A and 5B, are representative of the trajectories of data set 117 stored in memory 115 in FIG. 1. In all cases, the trajectories are pre-computed prior to runtime. At runtime, the trajectories are used as training data for a local model executed by a controller to develop and implement a control policy. The trajectories may be precomputed in accordance with a number of suitable algorithms, of which LQR and iLQR are representative. However, as is discussed briefly above and in more detail below, the time-dependent nature of iLQR results in sub-optimal trajectories. Accordingly, a modified version of iLQR is disclosed herein that removes the time-dependency of iLQR and produces time-invariant trajectories that overcome the aforementioned shortcomings. FIG. 6 illustrates a process 600 for generating said time-invariant trajectories.

Process 600 may be implemented in program instructions in the context of software or firmware executed by the circuitry of one or more processing devices of a single computing device or distributed across multiple computing devices, examples of which include special purpose controllers, general purpose computing devices, or the like. The program instructions, when executed by one or more processing devices of one or more computing devices, direct the one or more computing devices to operate as follows, referring parenthetically to the steps in FIG. 5, and to a computing device in the singular for the sake of clarity

In operation, a suitable computing device performing process 600 initializes an iLQR algorithm with respect to its forward simulation or forward pass (step 601). Initializing the algorithm include, for example, defining the system dynamics, discretizing the system dynamics, and specifying a cost function.

The computing device then executes the iLQR algorithm to compute a trajectory xₖ that reaches the neighborhood of a goal state (step 603). The iLQR algorithm at this point is in an unmodified state in that it utilizes a time-dependent cost function that results in time-dependent solutions. Thus, across multiple trajectories, there may be states in-common that have conflicting or interfering control actions. For example, one trajectory at a certain location may produce a control action that directs a vehicle to turn left, while another trajectory at the very same location—but at a different time—may produce a control action that directs the vehicle to turn right. However, an average of the two is unacceptable since it comes to no turn at all.

To mitigate or overcome such limitations, process 600 proceeds upon completion of the iLQR algorithm to linearize the dynamics around the goal state (step 605) and then to compute the steady-state or constant value function of the corresponding LQR algorithm (step 607). The constant value function is time-invariant (not time-dependent) and may be computed analytically using the cost function(s) of the linearized dynamics.

The constant value function is used by the computing device when performing an additional backward recursion step of the iLQR algorithm (step 609). The solution arrived at by the iLQR algorithm above at Step 603 is further refined by the execution of another backward pass, but one using the constant value function rather than a time-dependent value function. The results include time-invariant gains rather than time-dependent gains.

The time-invariant iLQR algorithm may thus be considered a “modified” version of the standard algorithm by virtue of the additional backward pass using the constant value function. The trajectories produced by this method will be time invariant in that their nominal controls and gains associated with each point on a given trajectory will depend on where the points are in the state space, but not on when the controller uses them. This is achieved by the same computational mechanism as the basic iLQR method, but initializing the backward iteration differently, with the cost-to-go of an LQR controller at the goal state, and not with the terminal cost, as in the original or standard iLQR method.

### Supplemental Discussion

The following provides a supplemental discussion of the disclosed technology, associated problems solved by the disclosed technology, and various advantages and technical effects provided by the MBL controller technology proposed herein.

### 1. Introduction

Computing an optimal feedback controller for an arbitrary non-linear system is very difficult in the general case, and usually various custom solutions are employed for specific classes of non-linear systems. In some cases, an optimal trajectory can be computed for a given initial and goal state, and executed in open-loop. This would not work well when disturbances are present, but if the optimal trajectory is re-computed quickly, and only the first control from it applied at each control step, a form of closed loop control can be achieved (commonly called model-predictive control, MPC). However, the success of such MPC schemes often depends on the length of the predictive horizon over which trajectories are computed. For some systems, relatively short horizons are sufficient, but for others, such as non-minimum phase systems where the controller needs to move away from the goal state initially and approach it only later, the recomputation of the entire trajectory to the goal at each control step might be necessary, placing big demands on computing power and effectively reducing the achievable control rate. This limits the applicability of such entirely online methods (also called implicit MPC schemes).

Another, very different approach is to use model-free reinforcement learning algorithms to compute off-line a true universal feed-back control policy by means of repeated trial and error, and execute the policy online. This approach is also known as explicit MPC in the control systems community. A recent incarnation of this idea, known as deep reinforcement learning (DRL) uses deep-neural nets to store the control policy (and possibly, the value function) in a deep neural net, significantly increasing the dimensionality and complexity of problems that can be solved this way. Major recent algorithmic advances in DRL have largely eliminated one of the traditional weaknesses of RL—the inability to deal with continuous state and control spaces, and recent algorithms such as DDPG, TRPO, SAC, A3C, etc. are fully capable of finding good control policies in continuous state and control spaces. The computed policies that are stored in deep neural nets can typically be executed very quickly, allowing for very high control rates. However, this approach has a number of significant shortcomings, too. First, when model-free algorithms are used, the resulting derivative-free optimization methods for finding the optimal policy are excruciatingly slow and data inefficient. Furthermore, computing optimal decisions for all parts of the state space might not even be necessary, depending on how the controller will be used.

A very useful middle ground is occupied by algorithms that make full use of model derivatives to compute optimal state and control trajectories, but in addition also compute locally optimal control laws that are valid in the vicinity of the optimal trajectory, so they are, in fact, closed-loop controllers. Examples of such algorithms are the Differential Dynamical Programming (DDP) algorithm and its more modern and computationally efficient variant the Iterative Linear Quadratic Regulator (iLQR) algorithm. However, their control laws are valid only in a relatively small part of the state space and risk losing control. To combat this, DDP and iLQR can be executed in implicit MPC style, continuously recomputing the trajectory to the goal state, which is still very computationally heavy.

To address the shortcomings of both general DRL algorithms and those based on DDP, the Guided Policy Search (GPS) algorithm uses a combination of the two that leverages both the fast computation of DDP/iLQR as well as the expressive power and generalization abilities of deep neural networks. The GPS algorithm does this by solving an iLQR problem from multiple starting points, generating a number of training examples matching state to control from these solutions, and loading these examples into a deep neural net by training the net to match the states (or, higher-dimensional observations, if states are not directly observable at run-time), to controls. By leveraging the generalization (essentially, interpolation) abilities of neural nets, a full control policy can be computed over the entire part of the state space covered by the examples. However, using neural nets has the associated problems of long training times and lack of guarantees about convergence. Furthermore, neural nets do not enforce consistency between examples.

The current discussion proposes an alternative method for combining multiple local iLQR solutions into one global policy, described above with respect to FIGS. 1-5, and supplemented below.

### 2. Memory Based Learning for Constructing Global Nonlinear Control Policies

This section states the general control problem targeted by the proposed algorithm, reviews the operation of trajectory optimization methods based on differential dynamic programming, and then proposes a method for combining multiple solutions into a global policy that uses memory-based learning schemes, such as nearest-neighbor learning.

### A. Problem Statement

Consider the problem of stabilizing a non-linear time-invariant dynamical system described by the discrete dynamics equation xₖ₊₁=f(xₖ, uₖ), where x is a multidimensional continuous state space, u is a continuous control vector, and f is a non-linear time-invariant function. Of primary concern Are control problems where the objective is to bring the system from an initial state x₀ to a goal state x^{(G)} in some optimal way. This formulation of the control problem corresponds to both stabilization problems, where x^{(G)} is a set-point, as well as planning problems, where x^{(G)} is possibly quite far from the initial state x₀, and reaching the goal cannot always be computed by gradually reducing the feedback error x^{(G)}−xₖ, but requires traversing a complicated trajectory that might temporarily increase the feedback error before bringing it to zero. Instances of such planning problems arise when the system has unstable open-loop dynamics, for example is non-minimum phase, or is underactuated due to control limits or reduced number of control inputs. Computing control laws for such systems has long been studied both in the fields of control systems engineering as well as artificial intelligence and robotics.

The desired optimality of the computed control law is expressed by means of a cumulative cost J₀ that is the sum of running costs l and a final cost l_{f}, where the summation is computed over a sequence of control steps:

$${J}_{0} ( {x}_{0} , U ) = {\sum }_{k = 0}^{H - 1} l ( {x}_{k} , {u}_{k} ) + {l}_{f} ( {x}_{H} ) ,$$

where the states xₖ, k>0 follow the dynamics defined above starting from x₀, and U={u₀, u₁, . . . , u_{H}} is the control sequence applied over a finite horizon of length H time steps. Here, a finite horizon is needed to avoid infinite cumulative costs. (In contrast, DRL algorithms typically use infinite discounted cumulative costs/rewards.) By providing suitable positive running costs l, desired minimum-time objectives can be achieved. The problem of trajectory optimization is usually meant to consist of finding an optimal sequence of controls U*=arg min_{U}J₀ (x₀, U) from a specific starting state x₀, and not from every state within the state space of the system.

### B. Trajectory Optimization Based on Differential Dynamic Programming

The DDP and iLQR algorithms solve this trajectory optimization problem very efficiently when the dynamics f and stage costs l are differentiable. Starting from an initial guess for the optimal control trajectory, they compute the resulting state trajectory by rolling out the dynamics forward, and then employing Bellman's principle of optimality to compute the optimal controls and partial costs-to-go starting from the goal state and proceeding backwards in time. (This use of back-to-front dynamic programming is the key to the computational efficiency of the procedure, and contrasts with the asynchronous and directionless way Bellman back-ups of the value function are computed in most DRL algorithms.) Once a new improved control sequence is computed, the forward and backward passes are iterated until convergence. This convergence is typically fast, but necessarily only to a local minimum of the cumulative cost. This, in its turn, contrasts with the convergence properties of algorithms such as value and policy iteration, which are guaranteed to converge to a global optimum, at least when the value function and policy are represented in a tabular format. (Although, when deep neural nets are used to represent them, as is the case with modern DRL algorithms, such global convergence can hardly be guaranteed, either.)

As noted above, even though DDP and iLQR computation is fast, it is usually not fast enough for real-time control, if the entire trajectory has to be recomputed at every control step. The highly influential GPS algorithm deals with this problem by using iLQR to precompute a large number of trajectories, starting from many initial states, and then using supervised machine learning to learn the mapping u=μ(x) from states x to controls u that effectively constitutes a complete policy, that is, a global control law.

This approach combines the remarkable approximation and generalization properties of deep neural nets with the high-speed of trajectory optimization based on differential dynamic programming. However, such approximation power does not come without perils. Supervised machine learning algorithms typically minimize the mean squared error (MSE) over the training set and have the unfortunate property of averaging the outputs of two training examples that happen to have the same input. That is, if the training algorithm sees two pairs of states and controls (xᵢ, uᵢ) and (xⱼ, uⱼ) such that xᵢ=xⱼ, but uᵢ≠uⱼ, then the best prediction for that state that minimizes the MSE would be (uᵢ+uⱼ)/2. It might well be the case, though, that the two examples come from different trajectories, and even though both uᵢ and uⱼ can be suitable controls for this state, their average might not be. For example, one control might prescribe going to the left of an obstacle, the other might prescribe going to the right of it, but their average would mean colliding with the obstacle, and is thus not a good solution.

C. A Memory Based Method for Combining Multiple iLQR Solutions

The proposed method follows the same general idea as that of the GPS algorithm: use multiple iLQR solutions from a representative number of starting states, and fuse them into a global policy by means of a machine learning approximator. Where the proposed method differs from GPS is in which machine learning method is employed, as well as what components of the iLQR solutions are used.

Instead of using deep neural networks for combining the multiple iLQR solutions, the proposed algorithm uses a class of memory-based learning (MBL) algorithms that are also often referred to as non-parametric methods in the field of statistics. These methods include the k-nearest neighbor (k-NN), locally weighted learning (LWL), and locally weighted regression (LWR) algorithms that have already found success in the field of learning control. They also have the distinct advantage that no computational effort needs to be spent on training-rather, all the training data is simply stored in memory, and a local predictive model is quickly constructed for a specific query point (model input) only after this query point has been identified.

The training data set D is organized as a large collection of input-output pairs

$$D = {\{ ( {x}_{i} , {y}_{i} ) \}}_{i = 1}^{N}$$

obtained from all time steps of all iLQR solutions. (If I iLQR solutions have been computed, each of length H time steps, then the data set will contain N=IH examples.) The inputs are states x obtained from the states of all iLQR solutions, and the outputs y contain other elements of those solutions. One possibility is that y=u, i.e. the output of the MBL model is directly the control to be applied when the system is in state x. This arrangement of the training data is often called direct inverse control in the field of learning control.

Given a training data set D stored in memory and a new query state x, a prediction ŷ(x)=g(x) is made by constructing a local model g specifically for the new query point x. Most MBL algorithms start with computing the Euclidean distance dᵢ=∥x−xᵢ∥₂ between the new query state x and the inputs x₂, 1≤i≤N of all the examples in the database. (The Euclidean distance can be weighted according to the scales of the individual components of the state space, if the scales differ.) Different MBL algorithms use this distance information differently, for example:

The k-NN algorithm's prediction is the average of the outputs of the k closest points:

$$\hat{y} ( x ) = {g}_{kNN} ( x ) = {\sum }_{i = 1}^{k} {y}^{( i )} / k ,$$

where y⁽ⁱ⁾ is the output of the i-th closest example.

In locally-weighted learning (LWL),

$$\hat{y} ( x ) = {g}_{LWL} ( x ) = \frac{{\sum }_{i = 1}^{N} {y}_{i} C ( {d}_{i} )}{{\sum }_{i = 1}^{N} C ( {d}_{i} )} ,$$

where C(d) is a suitably chosen kernel, typically rapidly decreasing as the distance d increases [7].

In locally-weighted learning (LWR), a local regression model of desired order (e.g., linear, quadratic, etc.) is fitted around the query point by weighting the prediction error on all examples according to the computed distances dᵢ and using a suitable estimation algorithm, such as weighted least squares.

Various MBL algorithms provide various trade-offs between prediction accuracy and computation time. Of particular interest as regards the disclosed application of MBL to global control policy construction are k-NN methods, due to their fast computation. Data structures such as k-d trees can be used for fast retrieval of the closest neighbors to a query point, and are particularly effective in low- to medium-dimensional query spaces, as their retrieval time scales logarithmically in the number of examples.

Another favorable property of specifically the 1-NN version is that by finding the closest state in any iLQR solution, it will always execute the action for that solution, thus avoiding the averaging problem associated with many other ML algorithms, as discussed above.

A method using as outputs y only the controls u from the iLQR solutions is called method MBiILQR-A, for Memory-Based iLQR with nearest Action. This method would have to rely on the approximation abilities of the chosen ML scheme to smoothly approximate between neighboring solutions. An alternative is to make use of the fact that the DDP and iLQR algorithms compute actual feedback controllers of the form û=uₖ+Kₖ(x−xₖ), where Kₖ are feedback gains specifically appropriate for time step k of the particular iLQR solution. When this controller is executed, if the state x follows the nominal trajectory xₖ, the computed control û will also follow exactly the nominal control trajectory uₖ. However, when x deviates from the trajectory xₖ, for example due to disturbance or real-world dynamics that differ from the model dynamics f(xₖ, uₖ) used by the algorithm, the controller will act to bring the system's state to the nominal trajectory through the gains Kₖ. This controller is valid typically only in the local neighborhood of the state space trajectory, but this matches very well the principle of operation of MBL schemes: they build a predictive model only in the local neighborhood of a query point.

Based on this reasoning, a second variation of the control construction method is proposed, where the outputs y of the data set D consist of not only the control u associated with a particular state x in an iLQR solution, but also the control gains K associated with that state: y=[u, K]. As MBL methods predict each of their outputs independently, and most of their computational effort is in computing the distances to the training examples, the addition of the gains K among the model's outputs does not change the computational complexity of the method. This version of the controller is referred to as MBiLQR-C, for nearest Controller.

However, when combining several trajectories generated by the iLQR method, the MBiLQR-C controller may encounter difficulties at specific junctions due to abrupt changes and lack of smoothness in the transitions between trajectories. For instance, within a small area around certain points, the control inputs might be contradictory. One remedy to this issue is to ensure that each reference point is chosen only a single time during a single control run. Another approach, described below, is to remove the explicit dependency of the iLQR solution on time, so that nearest-neighbor searches in space will choose between comparable solution elements.

### D. Time-Independent Solution of MBiLQR

For finite horizon problems, the optimal control of the LOG problem is linear in the state via a gain matrix, but this gain matrix is time-dependent. This gain matrix can be computed from the value function, which is time-dependent, too. Consider the linear time-invariant (LTI) discrete dynamic system of the form:

$${x}_{k + 1} = {Ax}_{k} + {Bu}_{k} \qquad ( 1 )$$

with stage cost

$$\frac{1}{2} {u}_{k}^{T} {Ru}_{k} + \frac{1}{2} {x}_{k}^{T} {Qx}_{k} ,$$

0≤k<H and final cost

$$\frac{1}{2} {x}_{H}^{T} {Q}_{H} {x}_{H} .$$

The value function for each state is a solution to the Riccati equation, which is solved iteratively, back to front. For finite horizon problems, the solution of the value function Vₖ is

$${V}_{k} = Q + {A}^{T} {V}_{k + 1} A - {A}^{T} {V}_{k + 1} {B ( R + {B}^{T} {V}_{k + 1} B )}^{- 1} {B}^{T} {V}_{k + 1} A ( 2 ) \qquad ( 3 )$$

The result is a sequence of quadratic forms for the value function, each valid everywhere in state space (for LTI systems), but different across time. The optimal control law is written as

$${u}_{k} = - {K}_{k} {x}_{k} \qquad ( 4 )$$

where Kₖ=(R+B^{T}Vₖ₊₁B)⁻¹B^{T}Vₖ₊₁A. Through the time-varying value function Vₖ, the gain matrix Kₖ and the reference trajectory uₖ are also time-varying, producing different controls for the same state x at different time steps k. (As is well known, for infinite-horizon problems on LTI systems, the value function is constant for all time steps, that is Vₖ=Vₖ₊₁ for all k≥0, and this property is used to find it and the associated feedback gains by solving Equation 2 at a fixed point; this is the foundation of the fundamental LQR method.)

The iLQR algorithm operates similarly to the finite-horizon version of the LQR algorithm, iteratively computing the value function back from the terminal state, but using different local dynamics for each time step resulting from local linearization around the state for that time step. It is applicable only to the finite-horizon setting, because it solves the problem numerically over a fixed horizon. However, even if it was possible to solve it in the infinite horizon setting, there will be different value functions around every state, because the dynamics change over the state space. Furthermore, the optimal control for the same state at different times do not have to be consistent, because the policy is time dependent. Consider the feedback controller of MBiLQR û=uₖ+Kₖ(x−xₖ). For the same system state x, differences in the reference control trajectory uₖ, reference state trajectory xₖ, and gain matrix Kₖ may arise across different solution trajectories. This variation implies that MBiLQR's output û(x) at state x could vary abruptly when switching from one controller to another, introducing potential challenges regarding the system's stability, robustness, and convergence. These inconsistencies, stemming from the solution's time-varying nature across different trajectories, could significantly impact MBiLQR's performance and reliability.

One possible solution involves integrating the iLQG algorithm's finite-horizon path from the initial to the goal state with the classical LQR method for infinite-horizon objectives at the goal state. The solution consists of linearizing the dynamics around the goal state and assuming that the terminal value function V_{H} of the iLQR solver is the solution of the infinite horizon LQR regulation problem for the LTI system with these linearized dynamics. Essentially, the proposed solution constructs an infinite-horizon optimal control problem consisting of two parts: the first part starts at the initial state and spans the first H steps, and the second part consists of stabilizing the system linearized around the goal state from time step H+1 to infinity. By doing so, we are modifying the iLQR algorithm to essentially compute a time-invariant solution of the optimal control problem; if it operates on an LTI system to begin with, it will simply compute (iteratively) the constant value function and gain matrix that the LQR method computes analytically. This strategy is predicated on the assumption that the goal will be reached within a period no longer than H steps, after which it will be perpetually maintained. In practice, to convert time-dependent gains to time-invariant ones, the following steps are taken:
1) Execute the original iLQR algorithm to compute a trajectory xₖ, 0≤k≤H such that the final state x_{H} necessarily reaches (the neighborhood of) the goal state x^{(G)}.
2) Linearize the dynamics around the goal state x^{(G)}, producing matrices A_{G} and B_{G}, and cost functions Q_{G} and R_{G}.
3) Compute analytically the steady-state value-function V_{G} of the corresponding LQR problem with matrices A_{G} and B_{G} and cost functions Q_{G} and R_{G}, for example by solving Equation 2 for V_{G}=V_{R}=Vₖ₊₁, plugging it on both sides of the equation.
4) Conduct an additional backward recursion step of iLQR by setting the iLQR final cost V_{H}=V_{G}.

### Empirical Evaluation

Empirical verification of these embodiments, illustrated in FIGS. 6-8 demonstrates that they can be very effective in solving various control problems at high control rates. In particular, the following describes the performance of some of the variants of the proposed method on a classical benchmark problem from the control systems literature: the task of swinging up and stabilizing a torque-limited pendulum (TLP) to and around its upper unstable equilibrium. The low dimensional state space of the task is suitable for visualizing the computed control policies, and the need for reaching and stabilizing around an unstable equilibrium makes the task quite difficult for traditional control methods.

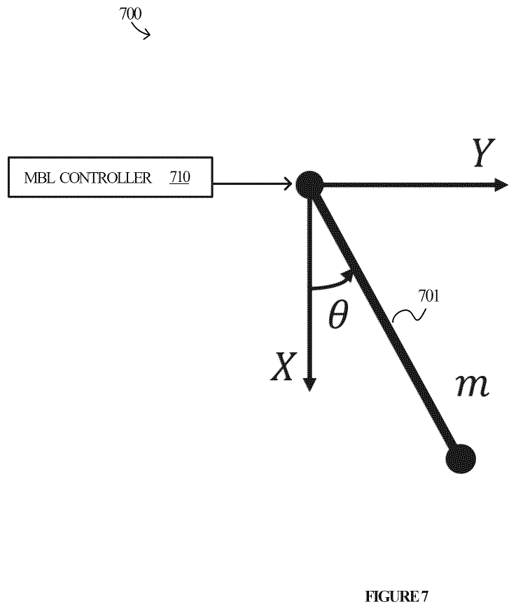

FIG. 7 illustrates an operational environment 700 in which an MBL controller as disclosed herein may be employed. Operational environment 700 includes a torque limited pendulum (TLP), or pendulum 701, controlled by an MBL controller 710. The pendulum 701, shown in FIG. 7, is governed by the equation mL\ddot{θ}=−mg sin θ−b\ddot{θ}+τ, where θ is its angle with respect to the stable vertical hanging position, m is the mass of its bob, L is its length, g is Earth's gravity, b is a viscous friction coefficient, and τ is the applied torque about the point the pendulum is suspended from. The goal is to swing it up from hanging position in the neighborhood of its lower stable equilibrium θ=0 to its upper unstable equilibrium θ=π and balance it there. Given enough torque, this is not difficult, as the torque can be applied against gravity. Once the pendulum reaches the unstable upper equilibrium, it can be stabilized there by a linear feedback controller, such as a PID controller or an LQR controller based on a linearization of the dynamics around the upper equilibrium.

However, when the torque is limited, the controller must pump enough energy into the pendulum by swinging it back and forth one or more times. This essentially turns the problem into a planning one. The analytical construction of such a controller/planner is not trivial, and insights into the physics of the system are necessary for a successful solution. This makes it a suitable benchmark for general-purpose controller-design methods such as the one proposed herein.

The first step in all variations of the proposed algorithm is to compute a set of I nominal iLQR solutions starting from multiple starting states. The success of the global control method proposed herein (and also of the GPS algorithm, for that matter) critically depends on the ability to find these local solutions reliably. The starting states were sampled from the subset of the state space such that −π/2≤θ≤π/2 (rad) and −3≤\dot{θ}≤3 (rad/s), reflecting that the objective of the task is to swing up the pendulum from a position generally below its suspension point.

Following the popular practice in the field of learning control when learning models of systems with rotational degrees of freedom expressed by angles, the pendulum's angle θ is represented with its sine and cosine. This avoids angle wrap-around at θ=±π and ensures continuity of functions on the angle there, which is assumed by most ML methods. As a result, the state space used by the iLQR algorithm is three dimensional: x=[sin θ, cos θ, \dot{θ}]. The control space is one-dimensional: u=τ.

Each execution of the iLQR algorithm consisted of 100 iterations of the algorithm, initialized with a completely random guess for the nominal control trajectory u[k], 0≤k≤H−1, where H=200 time steps. The following quadratic running and terminal costs were used: l(x, u)=(x−x_{g})^{T}Q(x−x^{(G)})+u^{T}Ru and l_{f}(x^{H})=(x^{H}−x^{(G)})^{T}Q_{f}(x^{H}−x^{(G)}), where the goal state, corresponding to the upper unstable equilibrium is x^{(G)}=[sin (π), cos (π),0]=[0,−1,0]. The following matrices produced reliable iLQR solutions that found a way to reach the goal state: Q=diag([10,100,1], R=[0.01], Q_{f}=diag([10,1000,1000]. The very low control cost signifies that the controller is free to saturate the control input while swinging up the pendulum (resulting in bang-bang control), which is known to be optimal in minimum-time problems with control limits.

A single execution of the iLQR algorithm in this setting took on average of 7.94 s on an i7-10750H CPU, implemented in Python. This number suggests that recomputing the entire trajectory at every control step would be way too slow for real-time control even if the implementation is optimized, but is otherwise acceptable for off-line construction of a training database.

Once an iLQR solution has been computed, a determination must be made whether it has reached the goal state by computing the distance d=∥x^{H}−x^{(G)}∥² between its terminal state x^{H} and the desired goal state x^{(G)}, and to add the trajectories to the dataset only if this distance is below a threshold ϵ: d≤ϵ. (A threshold of ϵ=0.2 was used here.) It may be appreciated that, in general, a full-state feedback (FSF) controller without integral action cannot always eliminate steady-state error, so many iLQR solutions converge to a terminal state with some steady-state error, where the pendulum is propped by a small amount of torque at an angle very close to the upper unstable equilibrium. Such solutions may be considered successful, as the FSF controller with terminal gains Ky will be able to reject disturbances around the upper equilibrium, and keep the pendulum in the goal region.

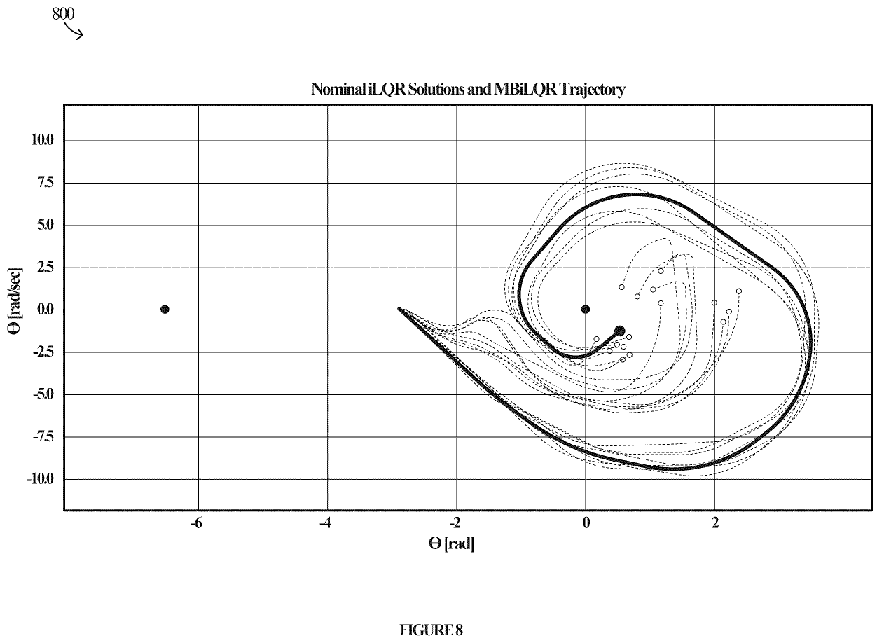

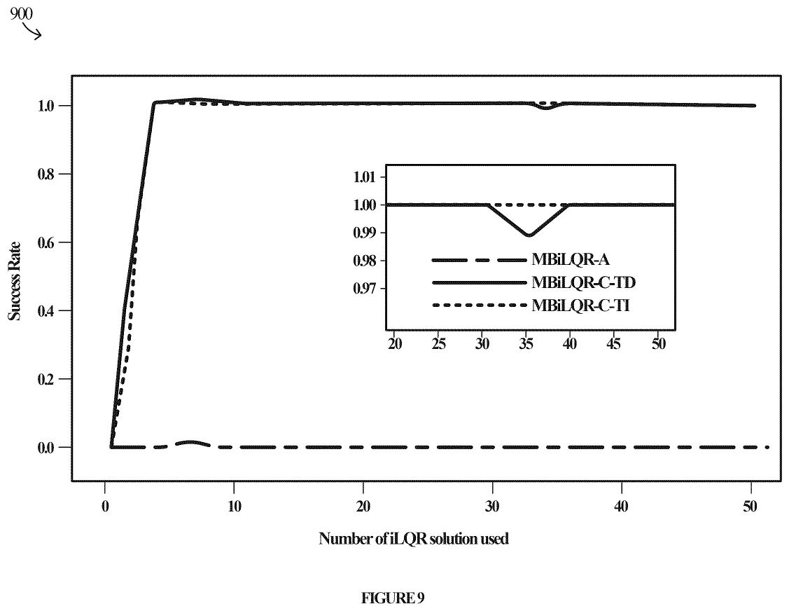

Consequently, the same criterion for success was adopted when the MBiLQR algorithm is run from a new starting point-whether the controller could bring the pendulum to the goal region, such that ∥x^{H}−x^{(G)}∥₂≤ϵ. 1,000 test executions were conducted from the same subset of the state space used for training, and the execution of one of them is superimposed on the training iLQR solutions in FIG. 7. FIGS. 8 and 9 illustrate empirical results. In particular, FIG. 8 illustrates a graph 800 that depicts a set of training trajectories and a computed trajectory mapped against the training trajectories. FIG. 9 illustrates a graph 900 that depicts the relative performance of three variations of the algorithms disclosed herein. It is visible that the iLQR solutions do not necessarily cover the state space uniformly, but tend to define a general preferred solution, even though they were computed completely independently from one another, with completely random initialization.

Also evaluated were the fraction of successes across the 1,000 test runs across 5 different random seeds, for a total of 5,000 random test cases as a function of how many iLQR solutions the MBiLQR algorithm was working with. The results, shown in FIG. 8, demonstrate that the basic version of the algorithms, MBiLQR-A, has very minimal success rate, reaching the goal only occasionally. In contrast, the more advanced MBiLQR-C time dependent (MBiLQR-C-TD) version of the algorithm shows the ability to bring the system to the goal state with very high success rates with even very few nominal iLQR solutions. However, it is not necessarily the case that more solutions monotonically increase the success rate. Furthermore, it shows some variance across different random seeds. In contrast, the MBiLQR time independent (MBiLQR-C-TI) version of the algorithm not only shows very high success rate, but has almost no variance across different random seeds. This demonstrates the clear advantage of using time-independent gains.

Note that each experiment with more iLQR solutions in memory included the exact same solutions as those experiments with fewer solutions before it, so any change in performance is due entirely to the additional solutions it is using. Furthermore, the control step computation time never exceeded 0.2 ms, even for the maximum number of solutions, allowing control rates in excess of 5 kHz.

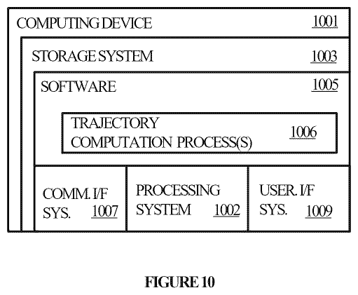

FIG. 10 illustrates computing device 1001 that is representative of any system or collection of systems on which the various processes, programs, services, and scenarios disclosed herein may be implemented. Examples of computing device 1001 include, but are not limited to, controller devices, micro controller units (MCUs), personal computers, server computers, cloud computing platforms, and data center equipment, as well as any other type of physical or virtual server machine, container, and any variation or combination thereof.

Computing device 1001 may be implemented as a single apparatus, system, or device or may be implemented in a distributed manner as multiple apparatuses, systems, or devices. Computing device 1001 includes, but is not limited to, processing system 1002, storage system 1003, software 1005, communication interface system 1007, and user interface system 1009. Processing system 1002 is operatively coupled with storage system 1003, communication interface system 1007, and user interface system 1009.

Processing system 1002 loads and executes software 1005 from storage system 1003. Software 1005 includes and implements trajectory computation process 1006, which is representative of process 200 and process 600. When executed by processing system 1002, software 1005 directs processing system 1002 to operate as described herein for at least the various processes, operational scenarios, and sequences discussed in the foregoing embodiments. Computing device 1001 may optionally include additional devices, features, or functionality not discussed for purposes of brevity.

Referring still to FIG. 10, processing system 1002 may comprise a micro-processor and other circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units, graphical processing units, digital signal processors, application specific processors, and logic devices, as well as any other type of processing device, combinations, or variations thereof.

Storage system 1003 may comprise any computer readable storage media readable by processing system 1002 and capable of storing software 1005. Storage system 1003 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some embodiments storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or possibly other systems.

Software 1005 (and trajectory computation process 1006) may be implemented in program instructions and among other functions may, when executed by processing system 1002, direct processing system 1002 to operate as described with respect to the various operational scenarios, sequences, frameworks, and processes illustrated and/or discussed herein. For example, software 1005 may include program instructions for implementing the processes described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1005 may include additional processes, programs, or components, such as operating system software, virtualization software, or other application software. Software 1005 may also comprise firmware or some other form of machine-readable processing instructions executable by processing system 1002.

In general, software 1005 may, when loaded into processing system 1002 and executed, transform a suitable apparatus, system, or device (of which computing device 1001 is representative) overall from a general-purpose computing system into a special-purpose computing system customized to perform trajectory computation processes in an optimized manner. Indeed, encoding software 1005 on storage system 1003 may transform the physical structure of storage system 1003. The specific transformation of the physical structure may depend on various factors in different embodiments of this description. Examples of such factors may include, but are not limited to, the technology used to implement the storage media of storage system 1003 and whether the computer-storage media are characterized as primary or secondary storage, as well as other factors.

For example, if the computer readable storage media are implemented as semiconductor-based memory, software 1005 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1007 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 1001 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A controller for controlling a dynamical system having nonlinear dynamics to a target state, comprising:
a memory configured to store a set of trajectories connecting various initial states with the target state, wherein each of the trajectories includes a sequence of points connecting an initial state with the target state, each point is associated with at least an intermediate state of the dynamical system, and gains of a feedback controller for controlling the dynamical system in the intermediate state, and wherein the trajectories are determined for an infinite time horizon resulting in time agnostic gains of the feedback controller; and
a processor configured to:
collect a current state of the dynamical system;
determine, using memory-based learning (MBL) on training instances derived from the set of trajectories, a control policy that defines a trajectory connecting the current state of the dynamical system with the target state; and
control the dynamical system according to the control policy.

2. The MBL controller of claim 1 wherein each of the trajectories further includes a cost-to-go from the intermediate state to the target state along a corresponding trajectory including the point, wherein at least some points of the corresponding trajectory are associated with different gains of the feedback controller, and wherein the trajectories determined for the infinite time horizon further result in the cost-to-go.

3. The MBL controller of claim 2, wherein the MBL uses a k-Nearest Neighbors (k-NN) method to interpolate one or a combination of the nominal controls and the gains and the cost-to-go of k-nearest points with intermediate states closest to the current state.

4. The MBL controller of claim 2, wherein the MBL uses a locally weighted learning (LWL) to interpolate one or a combination of the nominal controls and the gains and the cost-to-go of points weighted based on a non-linear function of distances from the intermediate states of the points to the current state.

5. The MBL controller of claim 2, wherein the MBL uses a locally-weighted learning (LWR) to interpolate one or a combination of the nominal controls and the gains and the cost-to-go of points weighted using a local regression model fitted around query points based on a non-linear function of distances from the intermediate states of the query points to the current state.

6. The MBL controller of claim 2, wherein the MBL interpolates the control actions and the feedback gains to produce an initial portion of a control trajectory connecting the dynamical system in the current state with an intermediate state of the local trajectory stored in the memory, wherein the MLB controller controls the dynamical system according to the control trajectory including the initial portion connecting the current state with the intermediate state followed by a remainder of local trajectory connecting the intermediate state with the target state.

7. The MBL controller of claim 2, wherein the MBL interpolates at least some costs-to-go of the local trajectory to sample points of state space around the current state of the dynamical system and to build a control trajectory according to sample points with the control actions and feedback gains determined by interpolations from nearest points of the local trajectories.

8. The MBL controller of claim 2, wherein the controller computes the expected cost-to-go of the current system state according to the estimates of the k nearest states from one of the stored trajectories, and chooses the controller associated with the trajectory state whose cost-to-go for the current system state is the lowest.

9. The MBL controller of claim 2, wherein the optimal control for the current system state is found by solving analytically or numerically the Hamilton-Jacobi-Bellman equation for this state and using MBL to interpolate the costs-to-go of all possible successor states in the neighborhood of the current state and also linearizing numerically the dynamics of the system around the system state.

10. A method of operating a controller to control a dynamical system having nonlinear dynamics to a target state, the method comprising:
storing, in a memory coupled with a processor, a set of trajectories connecting various initial states with the target state, wherein each of the trajectories includes a sequence of points connecting an initial state with the target state, each point is associated with an intermediate state of the dynamical system and gains of a feedback controller for controlling the dynamical system in the intermediate state, and wherein the trajectories are determined for an infinite time horizon resulting in time agnostic gains of the feedback controller; and
by the processor, at least:
determining a current state of the dynamical system;
determining, using memory-based learning (MBL) on training instances derived from the set of trajectories, a control policy that defines a trajectory connecting the current state of the dynamical system with the target state; and
controlling the dynamical system according to the control policy.

11. The method of claim 10 wherein each of the trajectories further includes a cost-to-go from the intermediate state to the target state along a corresponding trajectory including the point, wherein at least some points of the corresponding trajectory are associated with different gains of the feedback controller, and wherein the trajectories determined for the infinite time horizon further result in the cost-to-go.

12. The method of claim 11, wherein the MBL uses a k-Nearest Neighbors (k-NN) method to interpolate one or a combination of the nominal controls and the gains and the cost-to-go of k-nearest points with intermediate states closest to the current state.

13. The method of claim 11, wherein the MBL uses a locally weighted learning (LWL) to interpolate one or a combination of the nominal controls and the gains and the cost-to-go of points weighted based on a non-linear function of distances from the intermediate states of the points to the current state.

14. The method of claim 11, wherein the MBL uses a locally-weighted learning (LWR) to interpolate one or a combination of the nominal controls and the gains and the cost-to-go of points weighted using a local regression model fitted around query points based on a non-linear function of distances from the intermediate states of the query points to the current state.

15. The method of claim 11, wherein the MBL interpolates the control actions and the feedback gains to produce an initial portion of a control trajectory connecting the dynamical system in the current state with an intermediate state of the local trajectory stored in the memory, wherein the MLB controller controls the dynamical system according to the control trajectory including the initial portion connecting the current state with the intermediate state followed by a remainder of local trajectory connecting the intermediate state with the target state.

16. The method of claim 11, wherein the MBL interpolates at least some costs-to-go of the local trajectory to sample points of state space around the current state of the dynamical system and to build a control trajectory according to sample points with the control actions and feedback gains determined by interpolations from nearest points of the local trajectories.

17. The method of claim 11, wherein the controller computes the expected cost-to-go of the current system state according to the estimates of the k nearest states from one of the stored trajectories, and chooses the controller associated with the trajectory state whose cost-to-go for the current system state is the lowest.

18. The method of claim 11, wherein the optimal control for the current system state is found by solving analytically or numerically the Hamilton-Jacobi-Bellman equation for this state and using MBL to interpolate the costs-to-go of all possible successor states in the neighborhood of the current state and also linearizing numerically the dynamics of the system.

19. A control system for controlling a dynamical system having nonlinear dynamics to a target state, comprising:
a memory configured to store a set of trajectories;
one or more processors coupled with the memory and configured to:
determine a current state of the dynamical system;
determine, using memory-based learning (MBL) on training instances derived from the set of trajectories, a control policy that defines a trajectory connecting a current state of the dynamical system with the target state; and
control the dynamical system according to the control policy.

20. The control system of claim 17 wherein the one or more processors are further configured to pre-compute the set of trajectories prior to determining the current state of the dynamical system, and wherein, to pre-compute the trajectories, the one or more processors are configured to generate each of the set of trajectories by performing a set of steps comprising:
a) initializing an iterative Linear Quadratic Regulator (iLQR) algorithm;
b) performing a forward pass of the iLQR algorithm based at least on a time-dependent cost function, resulting in a forward solution;
c) performing a backward pass of the iLQR algorithm based at least on a time-invariant cost function, resulting in a backward solution;
d) repeat steps (b) and (c) until the forward solution and the backward solution have sufficiently converged to be accepted as a final trajectory; and
e) add the final trajectory to the set of trajectories;
wherein the final trajectory comprises a time-invariant trajectory.
